(19) United States
(12) Patent Application Publication
(10) Pub. No.: US 2011/0112687 A1
(43) Pub. Date: May 12, 2011

(54) ROBOT ARM

(75) Inventor: BO LONG, Shenzhen City (CN)

(73) Assignees: HONG FU JIN PRECISION INDUSTRY (ShenZhen) CO. LTD., Shenzhen City (CN); HON HAI PRECISION INDUSTRY CO., LTD., Tu-Cheng (TW)

(21) Appl. No.: 12/652,141

(22) Filed: Jan. 5, 2010

(30) Foreign Application Priority Data
Nov. 10, 2009 (CN) 200910309513.X

(51) Int. Cl. B25J 18/04; B25J 9/04

(52) U.S. Cl. 700/264; 901/27

(57) ABSTRACT

A robot arm includes a first rotation unit, a second rotation unit having a first end and a second end, a third rotation unit, a first pivot unit, and a second pivot unit. The first pivot unit pivotally connects the second rotation unit with the first rotation unit around a first axis. The first pivot unit includes a first driver received in the second rotation unit. The second pivot unit pivotally connects the third rotation unit with the second rotation unit around a second axis. The second pivot unit includes a second driver received in the third rotation unit and a transmission mechanism disposed between the second driver and the second rotation unit. The first driver and the second driver are disposed on the same side of the transmission mechanism, the first end and the second end of the second rotation unit are rotatably connected to the third rotation unit respectively.

### BACKGROUND

1. Technical Field

The present disclosure generally relates to robotics, and particularly, to an arm applied in a robot.

2. Description of Related Art

Industrial robots generally include arm portions pivotally connected in sequence. Each arm portion can rotate relative to the others when driven by an electrical engine. Performance parameters such as precision, loading ability, and stability are determined by position relationships and driving relationships among components arranged at the pivoting portions of the arm portions. In addition, industrial robots are required to be compact to conserve floor space.

Therefore, a robot arm addressing the limitations described is desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of a robot arm of an embodiment of the disclosure.

FIG. 2 is a cross-section of the robot arm taken along line II-II of FIG. 1.

FIG. 3 is an enlarged view of part of the robot arm of FIG. 2.

FIG. 4 is an enlarged view of a circled region IV of FIG. 2.

### DETAILED DESCRIPTION

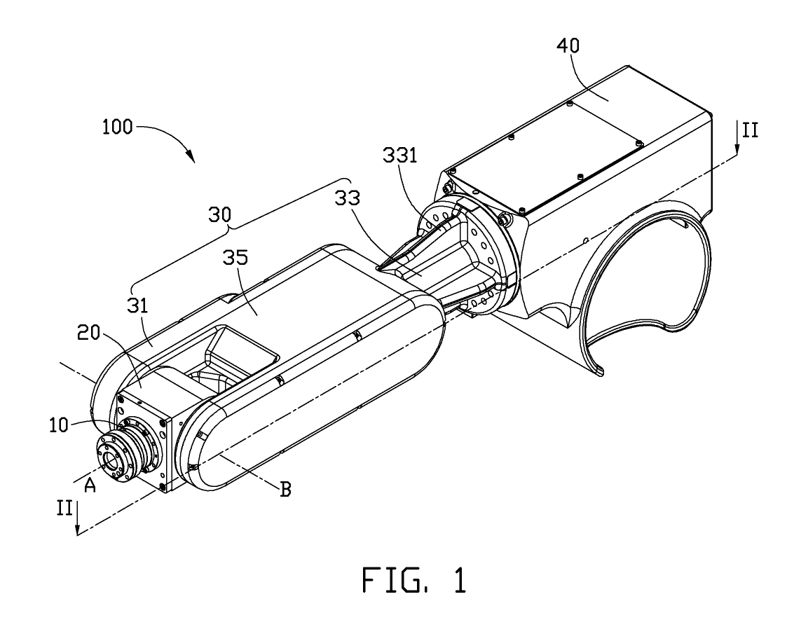

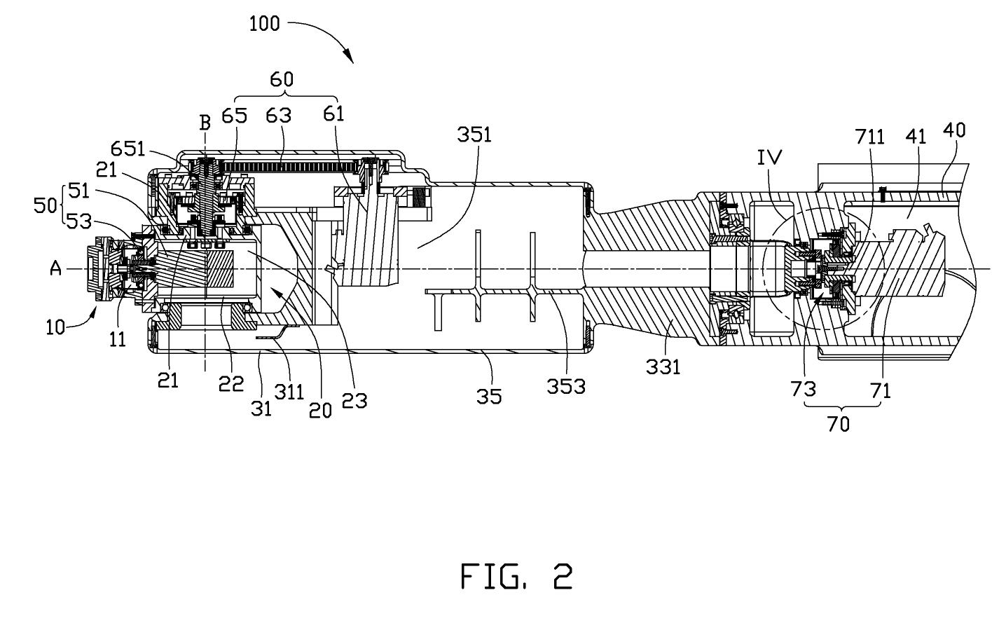

Referring to FIG. 1 and FIG. 2, an embodiment of a robot arm 100 is shown. The robot arm 100 includes a first rotation unit 10, a second rotation unit 20, a third rotation unit 30, and a fourth rotation unit 40 pivotally connected to each other in that order. The robot arm 100 further comprises a first pivot unit 50 pivotally connecting the first rotation unit 10 with the second rotation unit 20, a second pivot unit 60 pivotally connecting the third rotation unit 30 with the second rotation unit 20, and a third pivot unit 70 pivotally connecting the fourth rotation unit 40 with the third rotation unit 30.

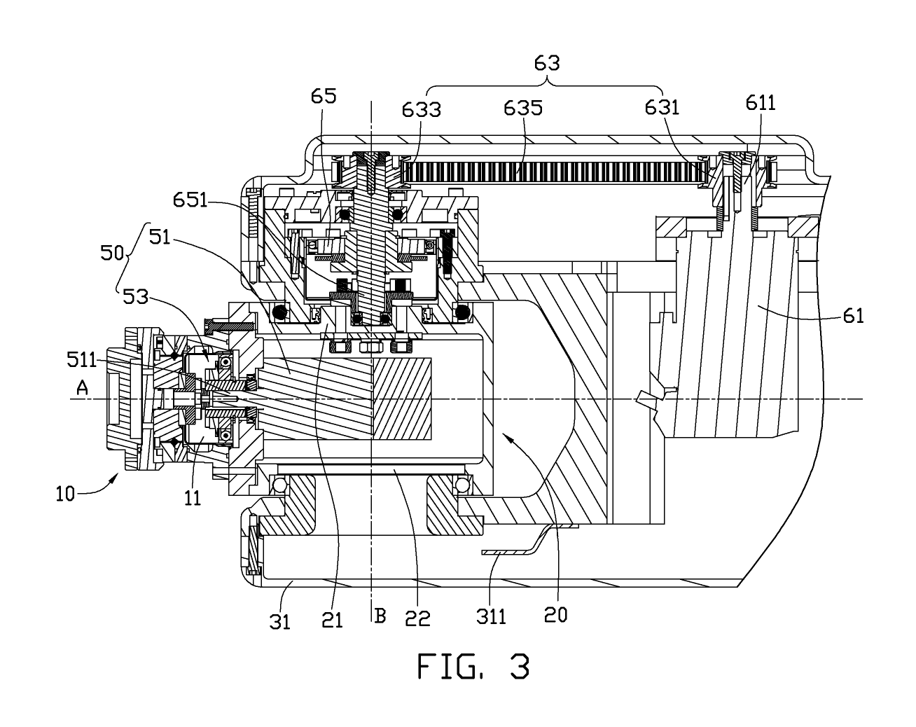

Referring also to FIG. 3, the first rotation unit 10 is disposed at a distal end of the robot arm 100. The first rotation unit 10 is rotatable relative to the second rotation unit 20 around an A-axis. The first rotation unit 10 includes a first cavity 11 therein.

The second rotation unit 20 is rotatable relative to the third rotation unit 30 around a B-axis. The second rotation unit 20 includes a first end 21 and a second end 22 formed at opposite ends thereof. The second rotation unit 20 includes a second cavity 23 therein. In the illustrated embodiment, the B-axis is perpendicular to the A-axis. Alternatively, the B-axis may be oblique to the A-axis.

The third rotation unit 30 is rotatable relative to the fourth rotation unit 40 around the A-axis. The third rotation unit 30 includes two ears 31, a pivoting portion 33, and a receiving portion 35 formed between the ears 31 and the pivoting portion 33. One of the ears 31 defines a clip 311. The pivoting portion 33 includes a plurality of ribs 331. In the illustrated embodiment, four ribs 331 are symmetrically formed on an outer surface of the pivoting portions 33. The receiving portion 35 includes a third cavity 351 and a plurality of ribs 353 formed therein. The second rotation unit 20 is disposed between the first end 21 and the second end 22. The first end 21 and the second end 22 of the second rotation unit 20 are rotatably connected to the ears 31, respectively.

The fourth rotation unit 40 includes a fourth cavity 41. The fourth rotation unit 40 is connected to a main body of a robot (not shown).

The first pivot unit 50 includes a first driver 51, and a first decelerator 53 driven by the first driver 51. The first driver 51 includes a first output shaft 511 rotated by the first driver 51. The first output shaft 511 is coaxial with the first rotation unit 10. The first rotation unit 10 is connected to the first output shaft 511 via the first decelerator 53, therefore, the first rotation unit 10 can be driven to rotate. The first driver 51 is received in the second cavity 23 of the second rotation unit 20, and the first output shaft 511 is received in the first cavity 11 of the first rotation unit 10. In the illustrated embodiment, the first decelerator 53 is a harmonic speed reducer, and the first driver 51 is an electrical motor. Alternatively, the first decelerator 53 may be of another kind, such as a decelerator using gears, and the first driver 51 may be an air cylinder or a hydraulic cylinder. The first decelerator 53 is mostly received in the first cavity 11 of the first rotation unit 10.

The second pivot unit 60 includes a second driver 61, a transmission mechanism 63, and a second decelerator 65. The transmission mechanism 63 is connected to the second driver 61 and the second decelerator 65 to transmit movement from the second driver 61 to the second decelerator 65. The second driver 61 includes a second output shaft 611 to connect with the transmission mechanism 63. The second driver 61 is received in the third cavity 351 of the third rotation unit 30, and the second output shaft 611 is received in the ear 31 connected to the first end 21 of the second rotation unit 20. The transmission mechanism 63 is received in the ear 31 connected to the first end 21 of the second rotation unit 20, and extends parallel to the A-axis. The second output shaft 611 rotates when the second driver 61 works. In the illustrated embodiment, the transmission mechanism 63 includes a driving wheel 631, a follow wheel 633, and a connecting member 635 encircling the driving wheel 631 and the follow wheel 633. The connecting member 635 may be a belt or a chain. When the connecting member 635 is a belt, the driving wheel 631 and the follow wheel 633 are belt pulleys. When the connecting member 635 is a chain, the driving wheel 631 and the follow wheel 633 are sprocket wheel. The second decelerator 65 includes a spindle 651 coaxially connected with the follow wheel 633 and parallel to the second output shaft 611.

The first driver 51, the spindle 651 and the second driver 61 are arranged on the same side of the connecting member 635 of the transmission mechanism 63. An end opposite to the first output shaft 511 of the first driver 51 protrudes toward the second driver 61. The driving wheel 631 is fixed to the second output shaft 611, and the follow wheel 633 is fixed to the spindle 651. In the illustrated embodiment, the second decelerator 65 is a harmonic speed reducer, and the second driver 61 is an electrical motor. Alternatively, the second decelerator 65 may be of another kind, such as a decelerator using gears, and the second driver 61 may be an air cylinder or a hydraulic cylinder.

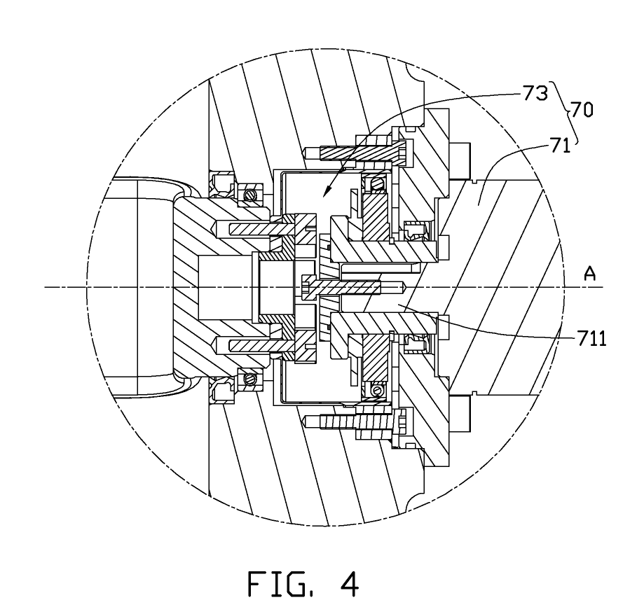

Referring to FIG. 2 and FIG. 4, the third pivot unit 70 is coaxial with the first pivot unit 50. The third pivot unit 70 includes a third driver 71, and a third decelerator 73 driven by the third driver 71. The third driver 71 includes a third output shaft 711. The third output shaft 711 rotates around the A-axis when the third driver 71 works. The third driver 71 is received in the fourth cavity 41 of the fourth rotation unit 40. The third decelerator 73 is disposed between the output shaft 711 of the third driver 71 and the third rotation unit 30, to transmit movement of the third driver 71 to the third rotation unit 30. In the illustrated embodiment, the third decelerator 73 is a harmonic speed reducer. Alternatively, the third decelerator 73 may be of another kind, such as a decelerator using gears.

In the robot arm 100, the first driver 51 and the second driver 61 can be disposed in the second cavity 23 of the second rotation unit 20 and the third cavity 351 of the third rotation unit 30 respectively, because the first rotation unit 10 is connected with the first driver 51 via the first decelerator 53 and the second rotation unit 20 is connected with the second driver 61 via the transmission mechanism 63. As such, the first driver 51 and the second driver 61 avoid reception in the same second rotation unit 20. In addition, since both the first end 21 and the second end 22 of the second rotation unit 20 are connected to the third rotation unit 30, the second rotation unit 20 has high stability.

Since no second pivot unit 60 is in the second end 22 of the second rotation unit 20, wires may pass through the second rotation unit 20 and the third rotation unit 30 and be clasped by the clip 311. Thus, the wires can avoid encircling the components.

The first, second, and third decelerators 53, 65, and 73 are harmonic speed reducers. Therefore, the robot arm 100 has enhanced transmission precision and loading ability, a small volume, a high transmission ratio and high stability, and low noise.

In alternative embodiments, when the first driver 51, the second driver 61 and the third driver 71 have low rotation speeds, the first, second, and third decelerators 53, 65, and 73 may be omitted.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot arm, comprising:
a first rotation unit configured to be disposed at a distal end of a robot;
a second rotation unit comprising a first end and a second end;
a third rotation unit;
a first pivot unit pivotally connecting the second rotation unit with the first rotation unit around a first axis, the first pivot unit comprising a first driver received in the second rotation unit; and
a second pivot unit pivotally connecting the third rotation unit with the second rotation unit around a second axis, the second pivot unit comprising a second driver received in the third rotation unit and a transmission mechanism disposed between the second driver and the second rotation unit;
wherein the first driver and the second driver are disposed on the same side of the transmission mechanism, with the first end and the second end of the second rotation unit rotatably connected to the third rotation unit respectively.

2. The robot arm of claim 1, wherein the first pivot unit further comprises a first decelerator connecting the first driver with the first rotation unit; and the second pivot unit further comprises a second decelerator connecting the transmission mechanism with the second rotation unit.

3. The robot arm of claim 2, wherein the first axis is substantially perpendicular to the second axis; and a rotation axis of the second driver is parallel to a rotation axis of the second decelerator.

4. The robot arm of claim 2, wherein the first decelerator and the second decelerator are harmonic speed reducers.

5. The robot arm of claim 2, further comprising a fourth rotation unit and a third pivot unit, wherein the third pivot unit rotatably connects the fourth rotation unit with the third rotation unit.

6. The robot arm of claim 5, wherein the third pivot unit comprises a third driver and a third decelerator connecting the third driver with the third rotation unit; the third driver received in the fourth rotation unit.

7. The robot arm of claim 6, wherein the third decelerator is a harmonic speed reducer.

8. The robot arm of claim 6, wherein the first decelerator and the third decelerator are coaxial with each other.

9. The robot arm of claim 6, wherein the second rotation unit further comprises a first cavity receiving the first driver, the third rotation unit further comprises a second cavity receiving the second driver, and the fourth rotation unit further comprises a third cavity receiving the third driver.

10. The robot arm of claim 9, wherein the first rotation unit further comprises a fourth cavity receiving the first decelerator.

11. The robot arm of claim 6, wherein the third rotation unit comprises two ears at an end thereof, and the first and second ends of the second rotation unit are rotatably connected to the ears of the third rotation unit respectively.

12. The robot arm of claim 11, wherein the second pivot unit is disposed between the first end of the second rotation unit and one of the ears of the third rotation unit.

13. The robot arm of claim 12, wherein the third rotation unit further comprises a wire clip formed on the other ear.

14. The robot arm of claim 2, wherein the transmission mechanism comprises a driving wheel, a follow wheel, and a connecting member encircling the driving wheel and the follow wheel; the driving wheel is connected to the second driver, and the follow wheel is connected to the second decelerator.
